(19) United States
(12) Patent Application Publication
(10) Pub. No.: US 2026/0298181 A1
(43) Pub. Date: Oct. 1, 2026

(54) EVAPORATIVE EMISSION LEAK DETECTION SYSTEM AND DETECTION METHOD FOR ENGINES

(71) Applicant: DIFITE (SUZHOU) CO., LTD., Suzhou (CN)

(72) Inventors: Yan ZHANG, Suzhou (CN); Yongjuan SHEN, Suzhou (CN); Xu ZHU, Suzhou (CN); Wei CHEN, Suzhou (CN); Xiaoming ZHU, Suzhou (CN)

(21) Appl. No.: 19/453,810

(22) Filed: Jan. 20, 2026

(30) Foreign Application Priority Data
Mar. 28, 2025 (CN) 202510384680.X

(51) Int. Cl. F02M 25/08

(52) U.S. Cl. CPC F02M 25/0818; F02M 25/0836; F02M 25/0854; F02M 2025/0845

(57) ABSTRACT

The invention provides an evaporative emission leak detection system and detection method for engines, of which the detection system is comprised of a fuel tank, a carbon canister, a diagnostic instrument and a pressure detector. The carbon canister is separately in fluid communication with the fuel tank and the intake system of the engine. The diagnostic instrument consists of an intake and a vent, and the first and second ventilation pathways are formed within the diagnostic instrument, wherein, the first ventilation pathway directly connects the intake to the vent, while the second ventilation pathway connects the intake to a booster assembly, a check valve and the vent in sequence. A pipeline switching assembly switches between the first ventilation pathway and the second ventilation pathway within the diagnostic instrument based on detection demands to achieve air connectivity between the intake and the vent.

### TECHNICAL FIELD

The present invention relates to the field of vehicle technology, particularly to the field of vehicle system detection technology. Specifically, it relates to an evaporative emission leak detection system and detection method for engines.

### BACKGROUND

In the prior art, the leak detection method of the evaporative emission control system is to install a DMTL module in the evaporative emission control system. The DMTL module is composed of a rotary vane pump driven by a motor and a solenoid valve. The internal flow channel of the module consists of a main chamber open to the atmosphere and a high-pressure chamber, where a reference hole for calibration is designed on the high-pressure chamber. The DMTL leak diagnosis module has two working states during diagnosis, namely reference mode and diagnostic mode, which are controlled and switched by the solenoid valve. When the electromagnetic coil is energized inside the solenoid valve, the electromagnetic force generated by the coil drives the iron core and valve to move together, thereby achieving the switch-on or switch-off of the valve. The switching of the solenoid valve is used to achieve two working conditions of the rotary vane pump, namely inflating the reference hole or the entire evaporative emission control system. The motor currents of the rotary vane pump under two operating conditions are detected, and then the detected currents are compared to judge whether a leak with a hole size of 0.5 mm or more exists. However, due to the small diagnostic current of the rotary vane pump, ranging from 20 to 50 mA, the diagnostic results are greatly affected by the environment, especially by such factors as air humidity, friction and wear of the rotary vane pump, foreign object jamming, etc. From the actual feedback in the market, the probability of misdiagnosis is relatively high.

Therefore, the prior art is subject to such technical problems as great environmental influence on, and high misdiagnosis rate of, the existing diagnostic method.

### SUMMARY OF THE INVENTION

The present invention mainly aims to provide an evaporative emission leak detection system for engines to solve such technical problems as great environmental influence on, and high misdiagnosis rate of, the existing diagnostic method in the prior art.

In order to achieve the above objectives, an evaporative emission leak detection system for engines is hereby provided according to one aspect of the present invention. The said detection system comprises a fuel tank, a carbon canister, a diagnostic instrument and a pressure detector. The carbon canister is separately in fluid communication with the fuel tank and the intake system of the engine, a fuel tank isolation valve is provided between the carbon canister and the fuel tank, and a carbon canister control valve is arranged between the carbon canister and the engine and used to control the fluid communication between the carbon canister and the engine. The diagnostic instrument comprises an intake and a vent, wherein the intake is connected to the atmosphere, while the vent is connected to the carbon canister; a booster assembly, a check valve assembly and a pipeline switching assembly are provided and the first and second ventilation pathways connecting the intake and the vent are formed inside the diagnostic instrument, wherein the first ventilation pathway directly connects the intake with the vent, while the second ventilation pathway sequentially connects the intake with the booster assembly, the check valve and the vent; the pipeline switching assembly switches between the first ventilation pathway and the second ventilation pathway within the diagnostic instrument based on detection demands to achieve air connectivity between the intake and the vent.

Furthermore, the pressure detector is arranged inside the fuel tank or in the pipeline between the fuel tank isolation valve and the fuel tank, or in the diagnostic instrument.

Furthermore, the diagnostic instrument comprises a shell, wherein the intake and the vent are arranged on the shell, and the first and second chambers are formed inside the shell and separately connected to the intake. The vent is connected to the second chamber, and the first chamber is connected to the second chamber and the vent through the first pipeline. The booster assembly is fixed to the shell and located on the side of the first chamber away from the first pipeline; the check valve assembly is connected to the shell, arranged within the first chamber and positioned between the booster assembly and the first pipeline; the pipeline switching assembly is located inside the second chamber and used to control the fluid communication between the first pipeline and the second chamber, so that the air pressurized by the booster assembly can pass through the check valve, the first pipeline and the second chamber, finally leave the shell through the vent and enter the carbon canister, when the first pipeline is connected to the second chamber.

Furthermore, the pipeline switching assembly comprises a solenoid valve, a sealing valve and a reset spring, of which one end is in contact with the elastic sealing part and the other end in contact with the first seat. The solenoid valve comprises a fixed core and an armature, a through hole is provided at the center of the fixed core, and at least a portion of the sealing valve passes through the central through hole of the fixed core. So, the sealing valve moves back and forth in the second chamber under the action of electromagnetic force and the reset spring.

Furthermore, the sealing valve comprises a handle, a frame and an elastic sealing part. One end of the handle passes through the central through hole of the fixed core, while the other end is detachably connected to the frame. The elastic sealing part is connected to the frame and can come into contact with the first seat under the action of the solenoid valve.

Furthermore, the check valve assembly comprises a second seat, wherein, at least a portion of the second seat is hermetically fixed to the shell, an installation hole provided at the center of the second seat and at least one ventilation hole arranged around the installation hole; an umbrella valve, which is fixed to the second seat through the installation hole, wherein at least a portion of the umbrella valve is made of elastic material, which covers the ventilation hole.

Furthermore, the second seat comprises a body and a connecting portion, wherein the connecting portion is cylindrical with one end open and extends from the body towards the first pipeline, and the outer wall of the connecting portion is fixed against the inner wall of the first pipeline.

According to another aspect, the present invention also provides an evaporative emission leak detection system for engines, which comprises a fuel tank, a carbon canister, a booster assembly, a check valve and a pressure detector. The carbon canister is separately connected to the fuel tank and the engine pipeline. A fuel tank isolation valve is provided between the carbon canister and the fuel tank and used to control the pipeline connection between the fuel tank and the carbon canister. The first carbon canister control valve is provided between the carbon canister and the engine and used to control the pipeline connection between the carbon canister and the engine. The pressure detector is used to detect the internal pressure of the fuel tank. The carbon canister is connected to the booster assembly through the check valve and also to the external air pipeline. The second carbon canister control valve is provided between the carbon canister and the external air and used to control air connectivity between the carbon canister and the external control.

According to another aspect, the present invention further provides an evaporative emission leak detection method for engines, which takes advantage of the detection system mentioned above and comprises the following steps:

Switch off the air pathway between the carbon canister and the external air, switch on the fuel tank isolation valve, and boost the internal pressure of the fuel tank to the first threshold P1 through the booster assembly; record the time difference Δt when the pressure in the fuel tank drops to the second threshold P2 and the third threshold P3; compare the time difference Δt with the preset time of the system, wherein, a leak in the system can be determined when the time difference Δt is smaller than the preset time of the system.

According to another aspect, the present invention further provides an evaporative emission leak detection method for engines, which takes advantage of the detection system mentioned above and comprises the following steps:

Switch off the air pathway between the carbon canister and the external air, switch on the fuel tank isolation valve, and boost the internal pressure of the fuel tank to the first threshold P1 through the pressure assembly; calculate the integral value S of the pressure P in the fuel tank from the moment when it reaches the second threshold P2 to the moment when it reaches the third threshold P3, namely

$$S = \int \text{?} P dt ;$$

$$\text{?} \text{indicates text missing or illegible when filed}$$

compare the integral value S with the preset value of the system, wherein, a leak in the system can be determined when the integral value S is smaller than the preset value of the system.

The evaporative emission leak detection system for engines released in this application can be used to control the pipeline of the carbon canister system by controlling the carbon canister control valve and fuel tank isolation valve, achieve different air connectivity between the intake and the vent of the diagnostic instrument through the pipeline switching assembly, and allow for pressurization or pressure maintenance of the carbon canister according to demands. So, it is beneficial for obtaining pressure information of the system and determining the operating status of the system based on the pressure information. This detection method reduces the reliability requirements of the diagnostic pump, minimizes external interference and ensures accurate detection results.

### DESCRIPTION OF DRAWINGS

The drawings, which form a part of this application, are used to promote further understanding of the present invention. The illustrative embodiments and relevant descriptions in the present invention aim to explain the present invention and do not constitute undue limitation to the present invention. In these drawings:

FIG. 1 shows a systematic diagram for the evaporative emission leak detection system for engines according to the present invention;

FIG. 2 shows a structural diagram for the diagnostic instrument according to the present invention;

FIG. 3 shows a cross-sectional view of the diagnostic instrument in the closed state of the solenoid valve according to the present invention;

FIG. 4 shows a cross-sectional view of the diagnostic instrument in the open state of the solenoid valve according to the present invention;

FIG. 5 shows a cross-sectional view of the booster assembly according to the present invention;

FIG. 6 shows a cross-sectional view of the solenoid valve according to the present invention;

FIG. 7 shows a cross-sectional view of the lower shell according to the present invention;

FIG. 8 shows the air flow diagram of the evaporative emission leak detection system when the diagnostic instrument is not working according to the present invention;

FIG. 9 shows the air flow diagram of the evaporative emission leak detection system when the diagnostic instrument is working according to the present invention.

The above drawings contain the following reference numerals:

10. Fuel tank; 20. Carbon canister; 30. Diagnostic instrument; 31. Shell; 311. Intake; 312. Vent; 313. The first chamber; 314. The second chamber; 3141. The first seat; 3142. The first vent; 315. The first pipeline; 316. Upper shell; 317. Lower shell; 32. Booster assembly; 33. Check valve assembly; 331. The second seat; 3311. Body; 3312. Connecting portion; 332. Umbrella valve; 3321. Connecting rod; 3322. Umbrella-shaped sealing part; 34. Pipeline switching assembly; 341. Solenoid valve; 3411. Fixed core; 3412. Armature; 342. Sealing valve; 3421. Handle; 3422. Frame; 3423. Elastic sealing part; 343. Reset spring; 344. Support; 3441. Ribbed plate; 3442. Stop ring; 40. Pressure detector; 50. Fuel tank isolation valve; 60. Carbon canister control valve; 70. Engine intake system.

### SPECIFIC EMBODIMENTS

In the following, specific embodiments of the present invention will be described in detail with reference to the drawings, but not as a limitation to the present invention.

It should be understood that various modifications can be made to the embodiments disclosed herein. Therefore, the above specification shall not be regarded as a limitation, but only as an example of the embodiments. Technicians in the art may consider other modifications within the scope and spirit of the present invention.

The drawings included in and forming a part of the specification illustrate embodiments of the present invention, and aim to explain the principles of the present invention together with the brief description of the present invention above and the detailed description of the embodiments below.

These and other features of the present invention will become apparent according to the description of the preferred embodiments given as non-limiting examples below and with reference to the drawings.

It should also be understood that those skilled in the art can certainly implement many other equivalent forms of the present invention, which have the features as claimed and are therefore within the scope of protection defined herein, although the present invention has been described with reference to specific examples.

The above and other aspects, features and advantages of the present invention will become more apparent in combination with the drawings and in the light of the following detailed description.

In the following, specific embodiments of the present invention will be described with reference to the drawings; however, it is to be understood that the disclosed embodiments are merely exemplary of the invention, which may be embodied in various forms. The well-known and/or repetitive functions and structures have not been described in detail for fear that unnecessary or redundant details may obscure the present invention. Therefore, specific structural and functional details disclosed herein are not to be interpreted as limiting, but merely as a basis for the claims and as a representative basis for teaching one skilled in the art to variously employ the present invention in virtually any appropriately detailed structure.

It should be noted that the terms “first”, “second”, etc. used herein are intended to distinguish similar objects, but do not necessarily describe a specific order or sequence. It should be understood that the data used in this way can be interchanged in appropriate circumstances, so that the embodiments described herein can be implemented in the order other than those illustrated or described herein. In addition, the terms “comprise” and “provided with”, as well as any variations thereof, are intended to cover non-exclusive containment, such as processes, methods, systems, products or devices containing a series of steps or units, which are not necessarily limited to those clearly listed, but may include other steps or units not clearly listed or inherent to these processes, methods, products or devices.

The phrases “in one embodiment”, “in another embodiment”, “in one more embodiment”, or “in other embodiments” used in this specification may refer to one or more of the same or different embodiments disclosed herein.

The present invention will be further described below in conjunction with the drawings and specific embodiments.

The present invention provides an evaporative emission leak detection system for engines to solve such technical problems as great environmental influence on, and high misdiagnosis rate of, the existing diagnostic method in the prior art.

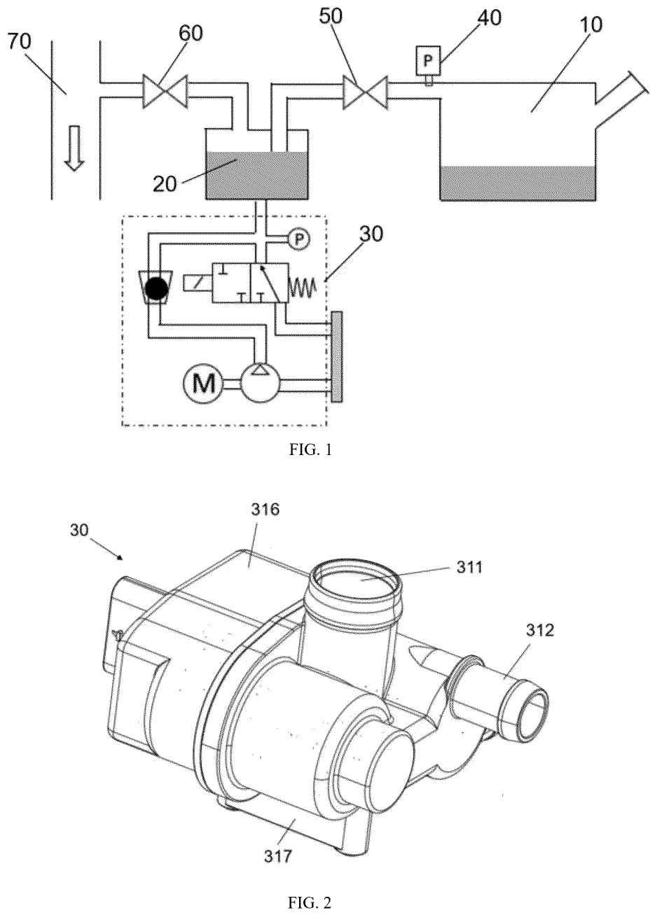

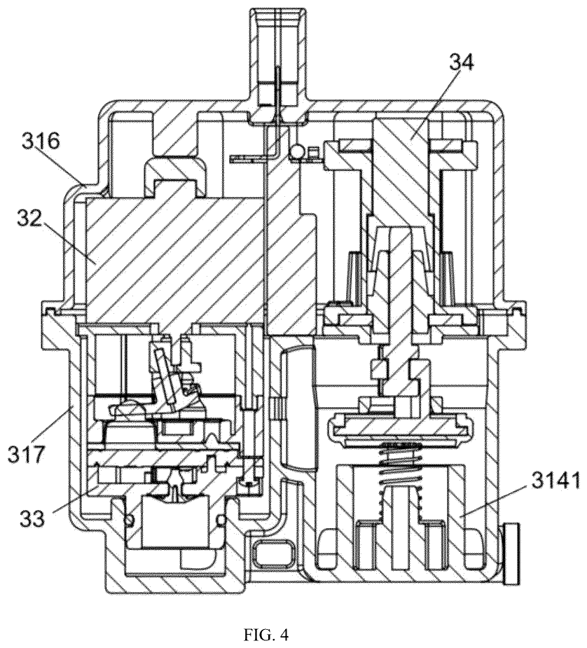

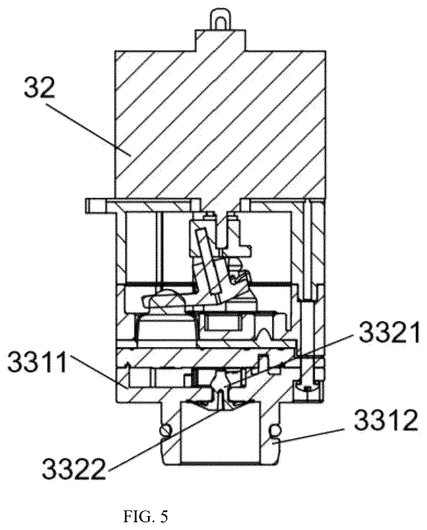

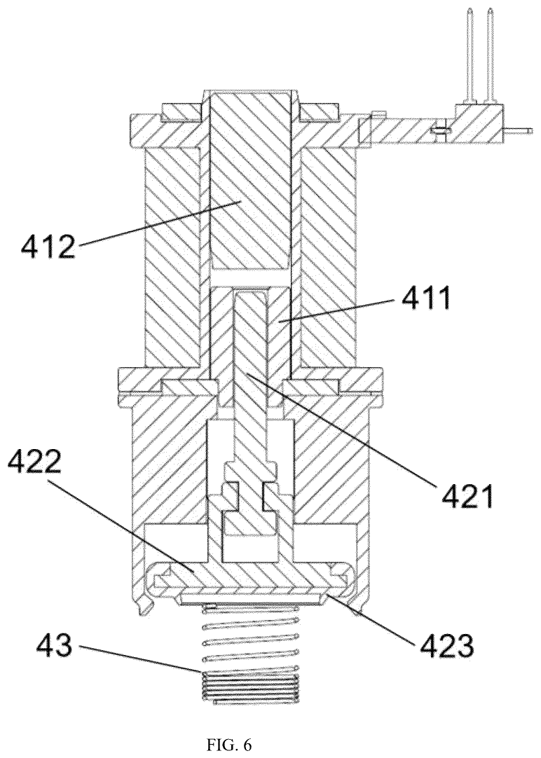

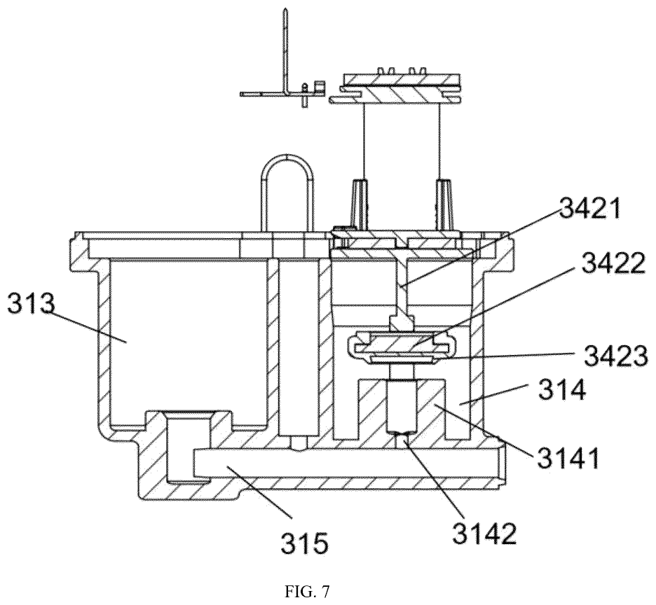

As shown in FIGS. 1 to 9, the present disclosure provides an evaporative emission leak detection system for engines, which comprises a fuel tank 10, a carbon canister 20, a diagnostic instrument 30 and a pressure detector 40. Wherein, the carbon canister 20 is in fluid communication with the fuel tank 10 and the engine intake system 70 through pipelines, so that fuel vapor inside the fuel tank 10 can be adsorbed through the carbon canister 20, avoiding direct discharge of fuel vapor from the fuel tank 10 into the atmosphere. A fuel tank isolation valve 50 is arranged between the carbon canister 20 and the fuel tank 10 and used to control the pipeline connection between the fuel tank 10 and the carbon canister 20. A carbon canister control valve 60 is provided between the carbon canister 20 and the engine intake system 70 and used to control the fluid communication between the carbon canister 20 and the engine intake system 70. The pressure detector 40 is used to detect pressure parameters within the detection system. The diagnostic instrument 30 consists of an intake 311 and a vent 312, wherein the intake 311 is connected to the atmosphere so that fresh air outside can enter the evaporative emission control system through the intake 311, while the vent 312 is connected to the carbon canister 20. A booster assembly 32, a check valve assembly 33 and a pipeline switching assembly 34 are provided and the first and second ventilation pathways connecting the intake 311 and the vent 312 are formed in the diagnostic instrument 30, wherein the first ventilation pathway directly connects the intake 311 and the vent 312, so that the carbon canister 20 can be directly linked to outside atmosphere through the intake 311, while the second ventilation pathway connects the intake 311 with the booster assembly 32, the check valve assembly 33 and the vent 312 in sequence. The pipeline switching assembly 34 switches between the first ventilation pathway and the second ventilation pathway within the diagnostic instrument 30 based on detection demands to achieve air connectivity between the intake 311 and the vent 312.

The evaporative emission leak detection system for engines released in this application can be used to control the pipeline of the carbon canister 20 system by controlling the carbon canister control valve 60 and the fuel tank isolation valve 50, achieve different air connectivity between the intake 311 and vent 312 of the diagnostic instrument 34 through pipeline switching assembly, and allow for pressurization or pressure maintenance of the carbon canister 20 according to demands. So, it is beneficial for obtaining pressure information of the system and determining the operating status of the system based on the pressure information. This detection method reduces the reliability requirements of the diagnostic pump, minimizes external interference and ensures accurate detection results.

Furthermore, the pressure detector 40 is arranged inside the fuel tank 10 or in the pipeline between the fuel tank isolation valve 50 and the fuel tank 10, or in the diagnostic instrument 30, to collect pressure parameters at different positions in the evaporative emission control system to represent pressure information within the evaporative emission control system; the pressure detector 40 may be a pressure sensor, whose type is not further limited in this application.

When arranged inside the fuel tank 10, the pressure detector 40 can be the built-in pressure sensor of the fuel tank 10, so that the pressure data of the system can be obtained without modifying hardware equipment during the assembly process. This setting method can avoid adding additional equipment and is conducive to reducing costs and improving the integration of the entire vehicle.

As shown in FIG. 2, the diagnostic instrument 30 comprises a shell 31 and an intake 311 and a vent 312 arranged on the shell 31. The first chamber 313 and second chamber 314 are formed inside the shell 31. The intake 311 is connected to the external air to provide fresh air to the system. The vent 312 is connected to the carbon canister 20 to selectively introduce high-pressure air or fresh air into the fuel tank 10 through the carbon canister 20. The first chamber 313 and the second chamber 314 are separately connected to the intake 311, and the vent 312 is connected to the second chamber 314. The first chamber 313 is connected to the second chamber 314 and the vent 312 through the first pipeline 315, so that the first chamber 313 has two air pathways connected to the external atmosphere and the vent 312, respectively, namely the first ventilation pathway and the second ventilation pathway.

Specifically, as shown in FIG. 2, the intake 311 can be placed in the middle of the shell and between the axes of the first chamber 313 and the second chamber 314. This method facilitates air connectivity between the first chamber 313 and second chamber 314 and the intake 311.

For example, the first chamber 313 can be connected to the intake 311 through the first opening formed on the side wall, and the second chamber 314 can be connected to the intake 311 through the second opening formed on the side wall. Wherein, the first opening and the second opening are both located on the pipe wall of the intake 311, so that the first chamber 313 and the second chamber 314 are directly connected to the intake 311. This setting method is conducive to accelerating the interaction speed among fluids and reducing processing costs. Preferably, the flow area of the second opening is larger than that of the first opening.

Furthermore, the shell 31 consists of an upper shell 316 and a lower shell 317, which are connected in a closed manner. The intake 311, the vent 312 and the first pipeline 315 are all located on the lower shell 317. The upper shell 316 is provided with an electrical connector for electrical connection with the vehicle. The first chamber 313 and the second chamber 314 are enclosed jointly by the upper shell 316 and the lower shell 317.

Optionally, the upper shell 316 and the lower shell 317 can be mutually connected via snap fasteners, or laser welded; both the upper shell 316 and the lower shell 317 are processed by integral molding, which not only reduces the cost but also further improves the airtightness of the shell.

The booster assembly 32 is fixed to the shell 31 and located on the side of the first chamber 313 away from the first pipeline 315. The booster assembly 32 can pressurize the air entering the first chamber 313 and transmit the pressurized high-pressure air to the check valve assembly 33. The check valve assembly 33 is connected to the shell and located within the first chamber 313 and between the booster assembly 32 and the first pipeline 315; thus, the high-pressure air transmitted from the booster assembly 32 can enter the first pipeline 315 through the check valve assembly 33. The check valve assembly 33 is arranged to limit the unidirectional transmission path from the first chamber 313 to the second chamber 314, to transfer high-pressure air to the carbon canister 20 and the fuel tank 10 through the second chamber 314.

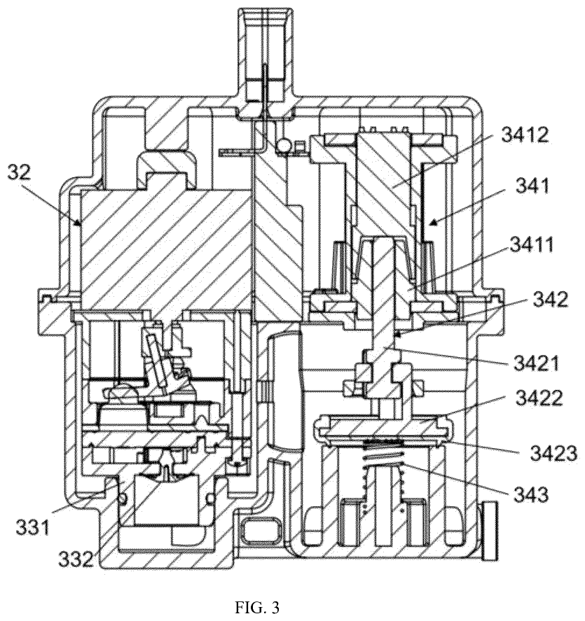

As shown in FIGS. 3 to 5, the booster assembly 32 contains an air pump, which is located inside the first chamber 313. The intake 311 of the shell 31 is connected to the chamber at the end of the air pump, and air enters the chamber at the pump end through the inlet. The outlet of the air pump is connected to the check valve assembly 33, and air passes through the air pump and then the check valve assembly 33, the second chamber 314 and the vent 312 in sequence, and finally enter the carbon canister 20 to establish pressure in the evaporation system.

For example, the air pump can be a diaphragm pump, which consists of a pump head and a brushed motor. The pump head is composed of a pump casing, two side covers, a diaphragm arranged inside the pump body, and an eccentric wheel arranged in the center of the pump casing and cooperating with a brushed motor. The air pump is driven by a brushed motor and each membrane is equipped with two air check valves. The air check valves are in an elastic valve structure and includes one inlet check valve and one outlet check valve of the diaphragm pump. The check valves cooperate with the diaphragm to achieve the functions of intake and exhaust during the pumping process. The specific type and structure of the air pump are not limited herein, and common air pumps in the prior art can be applied to this application as long as they can achieve air compression and transmission.

In order to prevent external impurities from entering the system and causing pipeline blockage during use, the second pipeline and the intake end of the air pump are also connected to air filters. The second pipeline and the intake end of the air pump can be connected to the same air filter through the same pipeline, or to different air filters through different pipelines.

The pipeline switching assembly 34 is located in the second chamber 314 and comprises a solute valve 341, a sealing valve 342 and a reset spring 343. The sealing valve 342 is connected to the solenoid valve 341 and controls the fluid communication between the first pipeline 315 and the second chamber 314 under the action of the solenoid valve 341. Therefore, when the first pipeline 315 is connected with the second chamber 314, the air pressurized by the booster assembly 32 can pass through the check valve, the first pipeline 315 and the second chamber 314 sequentially, finally leave the shell via the vent 312, and then enter the fuel tank 10 through the carbon canister 20.

Furthermore, a first seat 3141 in a cylindrical structure with one end open is provided on the side of the second chamber 314 near the first pipeline 315, and the bottom and/or side of the seat is connected to the vent 312. The sealing valve 342 can come into contact with the first seat 3141 under the drive of the solenoid valve 341, to close or open the ventilation path between the second chamber 314 and the vent 312. The first vent 3142 is arranged at the bottom of the first seat 3141 and connected to the first pipeline 315. Therefore, when coming into contact with the first seat 3141, the sealing valve 342 simultaneously cuts off the pathway between the second chamber 314 and the first chamber 313 and between the second chamber 314 and the outside world. At this time, the first chamber 313 is only directly connected to the carbon canister 20 through the first pipeline 315.

Preferably, a spring contact portion is formed inside the first seat 3141, and the first vent 3142 is set at the center of the spring contact portion. The outer diameter of the spring contact portion matches the inner diameter of the reset spring 343 to achieve rapid assembly positioning of the reset spring 343.

The solenoid valve 341 consists of a fixed core 3411 and an armature 3412. At least a portion of the sealing valve 342 passes through the central through hole of the fixed core 3411 and is positioned axially. Under the action of electromagnetic force and the reset spring 343, the sealing valve 342 reciprocates within the second chamber 314.

Specifically, the sealing valve 342 is composed of a handle 3421, a sealing valve frame 3422 and an elastic sealing part 3423. One end of the handle 3421 passes through the central through hole of the fixed core 3411, while the other end is detachably connected to the sealing valve frame 3422. The elastic sealing part 3423 is connected to the frame and can come into contact with the first seat 3141 under the action of the solenoid valve 341, thereby achieving sealing of the first seat 3141.

Preferably, the elastic sealing part 3423 is made of rubber and can be fixed to the frame by vulcanization. The handle 3421 is equipped with a first positioning ring and a second positioning ring, and the frame is provided with an installation part and a bypass opening. The handle 3421 is fixed to the installation part by the bypass opening, and achieves installation positioning of the installation part through the first positioning ring and the second positioning ring.

In order to ensure the smooth opening of the pathway, one end of the reset spring 343 is in contact with the elastic sealing part 3423, while the other end comes into contact with the spring contact part in the first seat 3141. After the solenoid valve 341 is powered off, the reset spring 343 drives the sealing valve 342 upwards to open the air path between the second chamber 314 and first pipeline 315 and the vent 312. Meanwhile, under the force of the reset spring 343, the sealing valve frame 3422 comes into contact with the step of the first positioning ring of the handle 3421, so that it is conducive to improving the connection stability between the handle 3421 and the frame.

Furthermore, the pipeline switching assembly 34 also includes a support 344 and a through hole is provided in the middle of the support 344. The sealing valve 342 is connected to the solenoid valve 341 through the through hole, and the support 344 is provided with a ribbed plate 3441 used to limit the movement path of the sealing valve 342. The sealing valve frame 3422 and the ribbed plate 3441 are in clearance fit in the circumferential direction to ensure circumferential positioning.

Where, three ribbed plates 3441 can be set and evenly distributed around the frame. A stop ring 3442 can also be set at the front end of the ribbed plate 3441 to further ensure the alignment of the frame during movement.

In another embodiment of the present application, the check valve assembly 33 consists of a second seat 331 and an umbrella valve 332, wherein at least a portion of the second seat 331 is hermetically fixed to the shell, an installation hole is provided at the center of the second seat 331 and at least one ventilation hole is located around the installation hole. Two or more ventilation holes (as the case may be) are evenly distributed around the installation hole. The umbrella valve 332 is fixed to the second seat 331 through the installation hole. At least a part of the umbrella valve 332 is made of elastic material, which covers the ventilation hole to achieve sealing of the ventilation hole. High pressure (if any) inside the first pipeline 315 may acts on the surface of the umbrella valve 332, causing the umbrella valve 332 to press against the ventilation hole, thereby achieving sealing of the ventilation hole.

Furthermore, the second seat 331 comprises a body 3311 and a connecting portion 3312, which is cylindrical with one end open and extends from the body 3311 towards the first pipeline 315, and the outer wall of the connecting portion 3312 is fixed in contact with the inner wall of the first pipeline 315.

In order to improve the airtightness of the system, an elastic sealing ring is provided between the outer wall of the connecting portion 3312 and the inner wall of the first pipeline 315, and a groove for installing the elastic sealing ring is provided on the outer circumference of the second seat 331. The installation groove is beneficial for installation and positioning of the elastic sealing ring; preferably, the elastic sealing ring can be an O-ring (for example).

The umbrella valve 332 consists of a connecting rod 3321 and an umbrella-shaped sealing part 3322. The handle 3421 and the umbrella-shaped sealing part 3322 are integrally formed, and the connecting rod 3321 is connected to the installation hole. The outer diameter of the handle 3421 gradually shrinks from the end connected to the umbrella-shaped sealing part 3322 towards the end away from the umbrella-shaped sealing part 3322. The connecting rod 3321 is equipped with a positioning part, which can come into contact with the side of the second seat 331 away from the first pipeline 315. This setting method is beneficial for the assembly and fixation between the handle 3421 and the second seat 331.

The umbrella-shaped sealing part 3322 is made of rubber and can cover the ventilation hole to achieve one-way sealing of the ventilation hole.

In another embodiment of the application, the shell can also be provided with the third chamber connected to the first pipeline 315, and the axes of the first chamber 313, the second chamber 314 and the third chamber are parallel. The third chamber is used to connect with a pressure sensor, so that pressure information in the system can be collected through the third chamber.

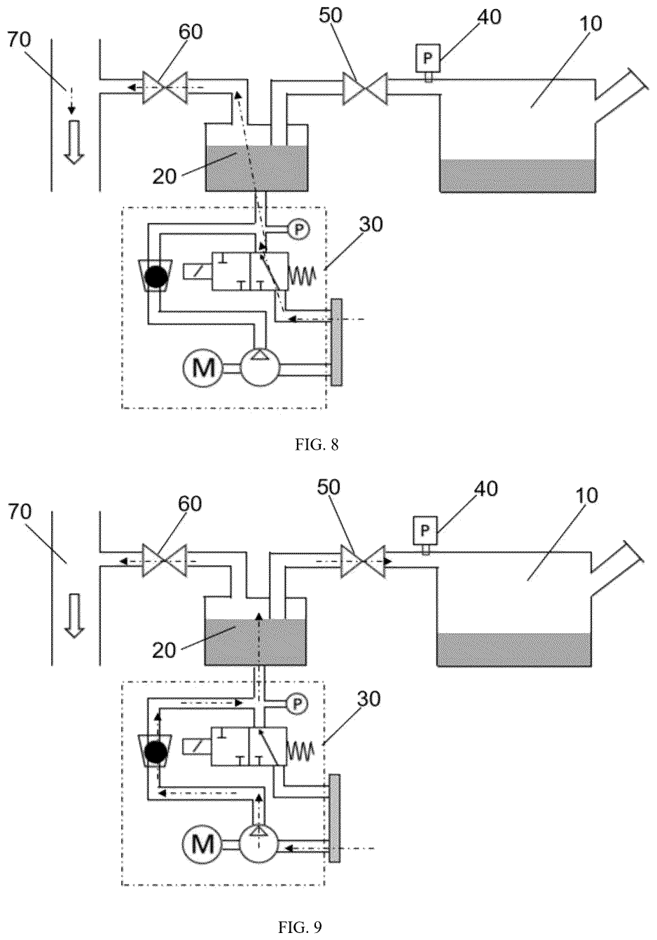

The solenoid valve 341 is normally open. During use, the fuel tank isolation valve 40 is powered off and switched off, the carbon canister control valve 60 is powered on and switched on, and the solenoid valve 341 is powered off and switched on, when the engine is running and the diagnostic instrument is not working. Then, the intake 311 and the vent 312 of the shell are directly connected within the second chamber 314. As indicated by the arrow in FIG. 8, external air flows into the diagnostic instrument through the intake 311 and then directly enters the carbon canister 20 from the vent 312, ensuring low air flow resistance during the desorption of the carbon canister 20. When the solenoid valve 341 is powered on and switched off, the passage between the intake 311 and the vent 312 inside the shell are cut off. Then, air must be pumped from the intake 311 of the shell to the check valve assembly 33 inside the shell via the air pump, and then enters the carbon canister 20 through the first pipeline 315 to form a stable pressure for monitoring leakage of the system.

According to another aspect, the application also provides an evaporative emission leak detection system for engines, which comprises a fuel tank 10, a carbon canister 20, a booster assembly 32, a check valve assembly 33 and a pressure detector 40. The carbon canister 20 is separately connected to the fuel tank 10 and the intake system 70 of the engine. A fuel tank isolation valve 50 is provided between the carbon canister 20 and the fuel tank 10 and used to control the pipeline connection between the fuel tank and the carbon canister. The first carbon canister control valve is provided between the carbon canister 10 and the intake system 70 of the engine and used to control the pipeline connection between the carbon canister 10 and the intake system 70 of the engine. The pressure detector 40 is used to detect the internal pressure of the fuel tank. The carbon canister 20 is connected to the booster assembly 32 through the check valve assembly 33 and also to the external air pipeline. The second carbon canister control valve is provided between the carbon canister 20 and the external air and used to control air connectivity between the carbon canister and the external control.

The first carbon canister control valve and the second carbon canister control valve can be solenoid valves, and can be switched on or off to achieve direct communication between the carbon canister and the external atmosphere or between the carbon canister and the check valve assembly.

According to another aspect, the application further provides an evaporative emission leak detection method for engines, which takes advantage of the detection system mentioned above and comprises the following steps:

During the operating process of the diagnostic instrument, the solenoid valve 341 is powered on and the sealing valve 342 comes into contact with the first seat 3141, cutting off the passage between the vent 312 and the intake 311, thereby breaking the air path between the carbon canister 20 and the outside air, as shown in FIG. 9 (arrow indicates the direction of airflow). At this point, the fuel tank isolation valve 50 is switched on to establish air connectivity between the fuel tank 10 and the carbon canister 20. The booster assembly 32 is activated to pressurize the fresh air from the intake 311. Then, the pressurized air passes through the check valve assembly 33 and the first pipeline 315, enters the carbon canister 20 via the vent 312, and ultimately flows into the fuel tank 10. Next steps include: pressurize the internal pressure of the fuel tank 10 to the first threshold P1; record the time difference Δt when the pressure in the fuel tank drops to the second threshold P2 and the third threshold P3; compare the time difference Δt with the preset time of the system, wherein, a leak in the system can be determined when the time difference Δt is smaller than the preset time of the system.

According to another aspect, the application further provides an evaporative emission leak detection method for engines, which takes advantage of the detection system mentioned above and comprises the following steps:

The solenoid valve 341 is powered on, and the sealing valve 342 comes into contact with the first seat 3141, cutting off the passage between the vent 312 and the intake 311, thereby breaking air connectivity between the carbon canister 20 and the outside air. The fuel tank isolation valve 50 is switched on, and the booster assembly is activated to pressurize the fresh air from the intake 311. Then, the pressurized air passes through the check valve and the first pipeline 315, enters the carbon canister 20 via the vent 312, and finally enters the fuel tank 10. Next steps include: pressurize the internal pressure of the fuel tank 10 to the first threshold P1; calculate the integral value S of the pressure P in the fuel tank from the moment when it reaches the second threshold P2 to the moment when it reaches the third threshold P3, namely

$$S = \int \text{?} P dt ;$$

$$\text{?} \text{indicates text missing or illegible when filed}$$

compare the integral value S with the preset value of the system, wherein, a leak in the system can be determined when the integral value S is smaller than the preset value of the system.

In the description of the present invention, it should be understood that directional words, such as “front, back, up, down, left, right”, “horizontal, vertical, perpendicular, horizontal”, and “top, bottom”, etc., usually indicate directional or positional relationships based on those shown in the drawings, and are only for the convenience of describing the present invention and simplifying the description. Unless otherwise stated, these directional words do not indicate or imply that the device or component referred to must have a specific orientation or be constructed and operated in a specific orientation. Therefore, these words cannot be understood as limiting the scope of protection of the present invention. The directional words “inside” and “outside” refer to the inside and outside relative to the contours of each component.

For convenience of description, spatial relative terms, such as “on”, “above”, “on the surface of”, “upper”, etc., can be used herein to describe the spatial positional relationship between a device or feature shown in the drawings and other devices or features. It should be understood that spatial relative terms are intended to encompass different orientations in use or operation in addition to the orientations of the devices described in the drawings. For example, if the device in the drawing is inverted, the device described as “above other devices or structures” or “on other devices or structures” should be positioned as “below other devices or structures” or “under other devices or structures”. Therefore, the exemplary term “above” may include two orientations: “above” and “below”. The device can also be positioned in other different ways (rotated by 90° or in other orientations), and corresponding explanations should be provided for the relative spatial description here.

In addition, it should be noted that the words, such as “first” and “second”, used to limit components, are only for the convenience of distinguishing corresponding components. If not otherwise stated, these words do not have a special meaning and therefore cannot be understood as limiting the scope of protection of the present invention.

The above description only provides preferred embodiments of the present invention and is not intended to limit the present invention. For those skilled in the art, the present invention may have various modifications and variations. Any modifications, equivalent substitutions, improvements, etc. made within the spirit and principles of the present invention shall fall squarely within the scope of protection of the present invention.

1. An evaporative emission leak detection system for engines, which is characterized in that the detection system comprises a fuel tank, a carbon canister, a diagnostic instrument and a pressure detector. The carbon canister is separately in fluid communication with the fuel tank and the intake system of the engine, a fuel tank isolation valve is provided between the carbon canister and the fuel tank, and a carbon canister control valve is arranged between the carbon canister and the engine and used to control the fluid communication between the carbon canister and the engine. The diagnostic instrument comprises an intake and a vent, wherein the intake is connected to the atmosphere, while the vent is connected to the carbon canister; a booster assembly, a check valve assembly and a pipeline switching assembly are provided and the first and second ventilation pathways connecting the intake and the vent are formed inside the diagnostic instrument, wherein the first ventilation pathway directly connects the intake with the vent, while the second ventilation pathway sequentially connects the intake with the booster assembly, the check valve and the vent; the pipeline switching assembly switches between the first ventilation pathway and the second ventilation pathway within the diagnostic instrument based on detection demands to achieve air connectivity between the intake and the vent. The diagnostic instrument further comprises a shell housing the intake, the vent, the first chamber and the second chamber, wherein the first and second chambers are separately connected to the intake, the vent is connected to the second chamber, and the first chamber is connected to the second chamber and the vent through the first pipeline. The booster assembly is fixed to the shell and located on the side of the first chamber away from the first pipeline; the check valve assembly is connected to the shell, arranged within the first chamber and positioned between the booster assembly and the first pipeline; the pipeline switching assembly is located inside the second chamber and used to control the fluid communication between the first pipeline and the second chamber, so that the air pressurized by the booster assembly can pass through the check valve, the first pipeline and the second chamber and finally leave the shell through the vent, when the first pipeline is connected to the second chamber.

2. The evaporative emission leak detection system for engines according to claim 1, characterized in that: the pressure detector is arranged inside the fuel tank or in the pipeline between the fuel tank isolation valve and the fuel tank, or in the diagnostic instrument.

3. The evaporative emission leak detection system for engines according to claim 1, characterized in that: the pipeline switching assembly comprises a solenoid valve, a sealing valve, and a reset spring, of which one end is in contact with the elastic sealing part and the other end in contact with the first seat. The solenoid valve comprises a fixed core and an armature, a through hole is provided at the center of the fixed core, and at least a portion of the sealing valve passes through the central through hole of the fixed core. So, the sealing valve moves back and forth in the second chamber under the action of electromagnetic force and the reset spring.

4. The evaporative emission leak detection system for engines according to claim 3, characterized in that: the sealing valve comprises a handle, a frame and an elastic sealing part. One end of the handle passes through the central through hole of the fixed core, while the other end is detachably connected to the frame. The elastic sealing part is connected to the frame and can come into contact with the first seat under the action of the solenoid valve.

5. The evaporative emission leak detection system for engines according to claim 1, characterized in that: the check valve assembly comprises:
a second seat, wherein, at least a portion of the second seat is hermetically fixed to the shell, an installation hole provided at the center of the second seat and at least one ventilation hole arranged around the installation hole;
an umbrella valve, which is fixed to the second seat through the installation hole, wherein at least a portion of the umbrella valve is made of elastic material, which covers the ventilation hole.

6. The evaporative emission leak detection system for engines according to claim 5, characterized in that the second seat comprises a body and a connecting portion, wherein the connecting portion is cylindrical with one end open and extends from the body towards the first pipeline, and the outer wall of the connecting portion is fixed against the inner wall of the first pipeline.

7. An evaporative emission leak detection method for engines, which takes advantage of the detection system according to claim 1 and comprises the following steps:
switching off the air pathway between the carbon canister and the external air, switching on the fuel tank isolation valve, and boosting the internal pressure of the fuel tank to the first threshold P1 through the booster assembly;
recording the time difference Δt when the pressure in the fuel tank drops to the second threshold P2 and the third threshold P3;
comparing the time difference Δt with the preset time of the system, wherein, a leak in the system can be determined when the time difference Δt is smaller than the preset time of the system.

8. An evaporative emission leak detection method for engines, which takes advantage of the detection system according to claim 1 and comprises the following steps:
switching off the air pathway between the carbon canister and the external air, switching on the fuel tank isolation valve, and boosting the internal pressure of the fuel tank to the first threshold P1 through the pressure assembly;
calculating the integral value S of the pressure P in the fuel tank from the moment when it reaches the second threshold P2 to the moment when it reaches the third threshold P3;
comparing the integral value S with the preset value of the system, wherein, a leak in the system can be determined when the integral value S is smaller than the preset value of the system.
